(19) United States
(12) Patent Application Publication
(10) Pub. No.: US 2020/0395588 A1
(43) Pub. Date: Dec. 17, 2020

(54) ADAPTIVE MICRO-BATTERY ARRAY USING ACTIVE CONTROL

(71) Applicant: Ming Chuan University, Taipei (TW)

(72) Inventors: Chung-Lin CHIA, Taipei City (TW); Jang-Jeng LIANG, Taipei City (TW); Yen-Hung TU, Taipei City (TW); Han-Chang CHEN, Taipei City (TW)

(21) Appl. No.: 16/855,648

(22) Filed: Apr. 22, 2020

(30) Foreign Application Priority Data
Jun. 11, 2019 (TW) 108120186

(51) Int. Cl. H01M 2/20; H01M 10/04; H01M 10/42

(52) U.S. Cl. CPC H01M 2/204; H01M 2010/4271; H01M 10/425; H01M 10/0436

(57) ABSTRACT

An adaptive micro-battery array including: a substrate having at least one charging and discharging port; a plurality of micro-battery units located on the substrate and each having at least one micro control unit and at least one energy storage unit; and a connecting network; where the connecting network and the micro control unit are formed on the substrate by a semiconductor fabrication process, and each of the micro-battery units is controlled by the at least one micro control unit therein to determine whether to make the at least one energy storage unit electrically connected to the connecting network, so that each of the at least one charging and discharging port is electrically connected with a corresponding micro-battery configuration.

### BACKGROUND OF THE INVENTION

### Field of the Invention

The present invention relates to a battery device, and more particularly to an adaptive micro-battery array using active control.

### Description of the Related Art

General battery devices have a set of electrodes (a positive electrode and a negative electrode) for supplying power to a load, or connecting to a charging power source for charging (if the battery device is a secondary battery device), and the battery electrical specifications (voltage rating, power rating, etc.) thereof are generally fixed.

However, when the power supply requirement of the load changes, the conventional battery device cannot adaptively change its battery electrical specifications. In addition, when one of the battery packs inside a conventional battery device fails, the conventional battery device may no longer be able to supply power to the load.

In order to solve the aforementioned problems, there is a need in the art for a novel adaptive micro-battery array using active control.

### SUMMARY OF THE INVENTION

One objective of the present invention to disclose an adaptive micro-battery array using active control that provides variable battery electrical specifications.

Another objective of the present invention is to disclose an adaptive micro-battery array using active control, which can provide multiple sets of charging and discharging ports, each of the charging and discharging ports can have different battery electrical specifications, and the charging and discharging ports can be charged or discharged independently in the same time.

Another objective of the present invention is to disclose an adaptive micro-battery array using active control, which can detect the status of internal micro-batteries and disable a failed micro-battery(ies).

Another objective of the present invention is to disclose an adaptive micro-battery array using active control, which can perform an energy balancing procedure on a plurality of internal micro-batteries.

Another objective of the present invention is to disclose an adaptive micro-battery array using active control, which can provide over temperature protection for a plurality of internal micro-batteries.

Another objective of the present invention is to disclose an adaptive micro-battery array using active control, which can provide overcurrent protection for a plurality of internal micro-batteries.

Another objective of the present invention is to disclose an adaptive micro-battery array using active control, which can integrate a capacitor, a solar cell, or a display element into an internal micro-battery unit.

Still another objective of the present invention is to disclose an adaptive micro-battery array using active control, which can be implemented on a flexible substrate using a semiconductor fabrication process.

To achieve the foregoing objectives, an adaptive micro-battery array using active control is proposed, which includes:

a substrate having at least one charging and discharging port;

a plurality of micro-battery units located on the substrate and each having at least one micro control unit and at least one energy storage unit;

a connecting network, located on the substrate and connected to the plurality of micro-battery units and the at least one charging and discharging port;

where the connecting network and the micro control unit are formed on the substrate by a semiconductor fabrication process, and each of the micro-battery units is controlled by the at least one micro control unit therein to determine whether to make the at least one energy storage unit electrically connected to the connecting network, so that each of the at least one charging and discharging port, which is electrically connected with the connecting network, is electrically connected with a corresponding micro-battery configuration, wherein the micro-battery configuration is formed by a series connection, a parallel connection, or a series and parallel combined connection of a plurality of the micro-battery units to provide a battery electrical specification.

For possible embodiments, the substrate can be a rigid or flexible substrate of organic material or inorganic material.

For possible embodiments, the semiconductor fabrication process can be a TFT panel fabrication process, a wafer fabrication process, or a thin film fabrication process.

For possible embodiments, the at least one micro control unit has at least one local control function selected from a group consisting of enabling or disabling at least one of the micro-battery units, setting a connecting configuration of the at least one energy storage unit of at least one of the micro-battery units, setting a charging current of at least one of the micro-battery units, setting an overcurrent protection function for at least one of the micro-battery units, setting an over temperature protection function for at least one of the micro-battery units, and setting an energy balancing function for the energy storage units of at least one of the micro-battery units.

In one embodiment, the connecting network includes a plurality of multiplexers coupled with the at least one charging and discharging port, and the multiplexers are formed on the substrate by the semiconductor fabrication process.

In one embodiment, the adaptive micro-battery array using active control further includes a configuration setting unit, and the configuration setting unit is electrically connected with the plurality of micro-battery units and the connecting network to configure the connecting network and the at least one micro control unit of each of the micro-battery units according to a configuration data, so as to set at least one said micro-battery configuration to provide at least one said battery electrical specification, and the configuration setting unit is formed on the substrate by using the semiconductor fabrication process or is an add-on chip on the substrate.

In one embodiment, the adaptive micro-battery array using active control further has a control unit coupled to the configuration setting unit to determine the configuration data to set at least one said micro-battery configuration, so as to provide at least one said battery electrical specification, and the control unit is formed on the substrate by using the semiconductor fabrication process or is an add-on chip on the substrate.

In one embodiment, the control unit is further coupled with the at least one charging and discharging port and has a power conversion function.

In one embodiment, the control unit further has at least one function selected from a group consisting of an overcurrent protection function, an over temperature protection function, and an inter-battery energy balancing function.

For possible embodiments, the energy storage unit includes a solid state battery or a solid state capacitor, or includes a solid state battery and at least one component selected from a group consisting of a solid capacitor, a solar cell and a display component, where the solid state battery or the solid state capacitor has a single layer structure or a multilayer stack structure.

In one embodiment, the substrate has at least two charging and discharging ports for performing at least one charging process and at least one discharging process simultaneously in at least two separate regions in the adaptive micro-battery array using active control.

In one embodiment, the micro control unit has at least one TFT switching element, and the connecting network includes a plurality of gate lines and a plurality of source lines.

In one embodiment, the micro control unit has a first transistor, a memory capacitor, and a second transistor, and the connecting network includes a plurality of gate lines and a plurality of source lines, where the first transistor and the memory capacitor are used to determine a control voltage, and the second transistor is configured to determine a charging or discharging current of one of the energy storage units according to the control voltage.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates an embodiment of an adaptive micro-battery array using active control of the present invention.

FIG. 2 is a block diagram showing an embodiment of a micro-battery unit of the adaptive micro-battery array using active control of FIG. 1.

FIG. 3 illustrates another embodiment of an adaptive micro-battery array using active control of the present invention.

FIG. 4 illustrates an embodiment of a micro-battery unit array of FIG. 3.

FIG. 5 illustrates another embodiment of the micro-battery unit array of FIG. 3.

FIG. 6 illustrates an operation scenario of the adaptive micro-battery array using active control of FIG. 1, where a charging process and a discharging process are performed in two separate regions of the micro-battery unit array simultaneously.

### DETAILED DESCRIPTION OF THE PREFERRED EMBODIMENTS

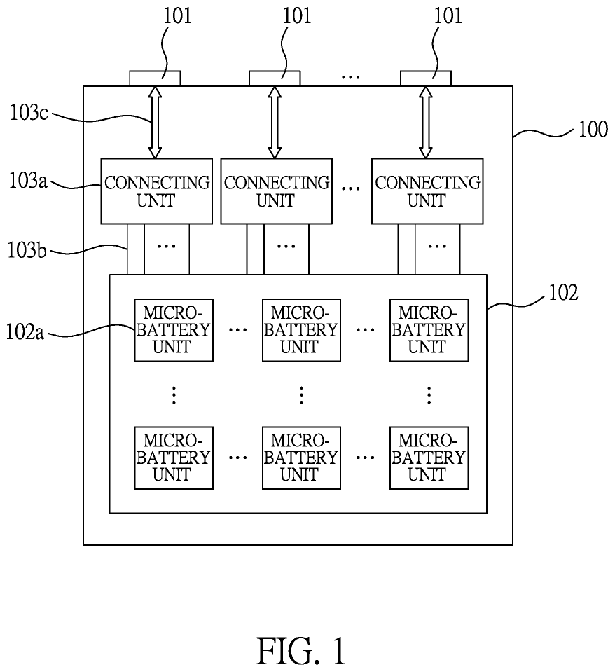

Please refer to FIG. 1, which illustrates an embodiment of an adaptive micro-battery array using active control of the present invention.

As illustrated in FIG. 1, the adaptive micro-battery array using active control includes a substrate 100, at least one charging and discharging port 101, a micro-battery array 102, a plurality of connecting units 103a, a plurality of first connecting lines 103b and a plurality of second connecting lines 103c, where the plurality of connecting units 103a, the plurality of first connecting lines 103b and the plurality of second connecting lines 103c are used to form a connecting network.

The substrate 100 may be a rigid or flexible substrate of an organic material or a hard or flexible substrate of an inorganic material, and the at least one charging and discharging connection 101 is disposed on the substrate 100.

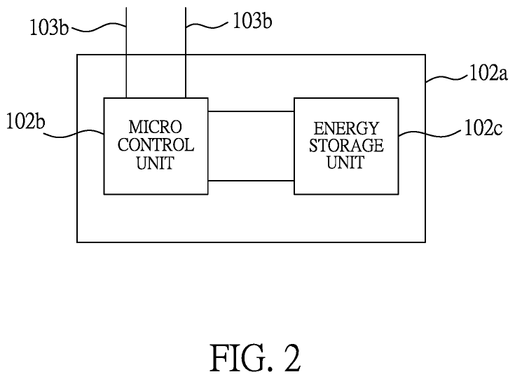

The micro-battery unit array 102 is located on the substrate 100 and has a plurality of micro-battery units 102a. Please refer to FIG. 2, which is a block diagram showing an embodiment of the micro-battery unit 102a of the adaptive micro-battery array using active control of FIG. 1. As illustrated in FIG. 2, the micro-battery unit 102a has a micro control unit 102b and an energy storage unit 102c. Preferably, the micro control unit 102b is formed on the substrate 100 by using a semiconductor fabrication process, and the semiconductor fabrication process can be a TFT panel fabrication process, a wafer fabrication process or a thin film fabrication process. In addition, for different requirements of current rating and conductive trace width, the micro-battery unit 102a may control the plurality of energy storage units 102c by one micro control unit 102b, or control one energy storage unit with plural micro control units 102b, or control a plurality of energy storage units 102c with a plurality of micro control units 102b. In addition, the energy storage unit 102c may include a solid state battery or a solid state capacitor, or include a solid state battery and at least one of the following components: a solid state capacitor, a solar cell, and a display component, where the solid state capacitor and the solar cell can enhance the power supply capability of the energy storage unit 102c, and the display element can display the status of the energy storage unit 102c (for example, display colors, text or symbols to indicate normal or abnormal). In addition, the solid state battery or the solid state capacitor may have a single layer structure or a multilayer stack structure.

The connecting network is located on the substrate 100 and connected with the plurality of micro-battery units 102a by a plurality of first connection lines 103b, and connected with the at least one charging and discharging port 101 by a plurality of second connection lines 103c, where the connecting network is formed on the substrate by a semiconductor fabrication process, and the semiconductor fabrication process can be a TFT panel fabrication process, a wafer fabrication process or a thin film fabrication process.

When in operation, each of the micro-battery units 102a is controlled by at least one micro control unit 102b therein to determine whether to connect at least one energy storage unit 102c with at least one first connection line 103b of the connecting network, so that each charging and discharging port 101 electrically connected with the connecting network is electrically connected with a corresponding micro-battery configuration, where the micro-battery configuration is formed by a series connection, a parallel connection, or a series and parallel combined connection of a plurality of the micro-battery units 102a to provide a battery electrical specification.

For possible embodiments, the micro control unit 102b has at least one local control function as listed below: enabling or disabling a micro-battery unit 102a; setting a connection configuration of at least one energy storage unit 102c of a micro-battery unit 102a; setting a charging current of a micro-battery unit 102a; setting an overcurrent protection function for a micro-battery unit 102a; setting an over temperature protection function for a micro-battery unit 102a; and setting an energy balancing function for plural energy storage units 102c of a micro-battery unit 102a.

In addition, preferably, the plurality of connection units 103a of the connecting network each include at least one multiplexer (not shown in the figure) for coupling with at least one charging and discharging port 101, and the at least one multiplexer is formed on the substrate 100 by using the semiconductor fabrication process.

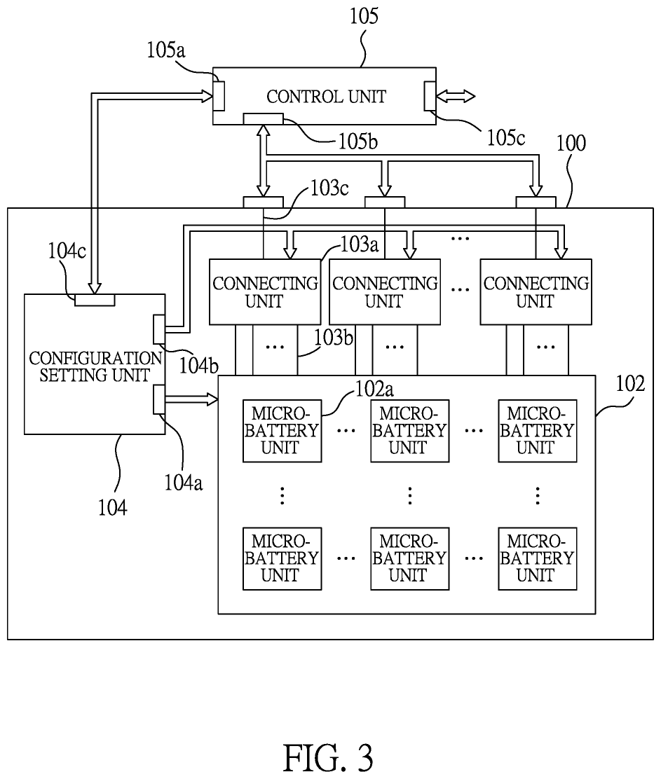

In addition, the adaptive micro-battery array using active control of FIG. 1 may further include a configuration setting unit and a control unit. Please refer to FIG. 3, which illustrates another embodiment of an adaptive micro-battery array using active control of the present invention. As illustrated in FIG. 3, the adaptive micro-battery array using active control includes a substrate 100, at least one charging and discharging port 101, a micro-battery array 102, a plurality of connecting units 103a, a plurality of first connecting lines 103b, a plurality of second connection line 103c, a configuration setting unit 104 and a control unit 105, where the plurality of connection units 103a, the plurality of first connection lines 103b and the plurality of second connection lines 103c are used to form a connecting network.

The description of the substrate 100, the at least one charging and discharging port 101, the micro-battery array 102, the plurality of connecting units 103a, the plurality of first connecting lines 103b, and the plurality of second connecting lines 103c is the same as the description for the counter parts of FIG. 1, and is therefore not to be repeated here.

The configuration setting unit 104 is formed on the substrate 100 by using the semiconductor fabrication process or is an add-on chip on the substrate 100, and has a configuration data, a first output port 104a, a second output port 104b, and an input port 104c, where the first output port 104a is used to electrically connect with a plurality of micro-battery units 102a, and the second output port 104b is used to electrically connect with a plurality of connecting units 103a of the connecting network, so as to configure the connecting units 103a of the connecting network and at least one micro control unit 102b of each micro-battery unit 102a according to the configuration data, and thereby set at least one said micro-battery configuration to provide at least one said battery electrical specification.

The control unit 105 is formed on the substrate 100 by using the semiconductor fabrication process or is an add-on chip on the substrate 100, and has an output port 105a, a first power port 105b and a second power port 105c, where the output port 105a is coupled with the input port 104c of the configuration setting unit 104 to provide the configuration data for determining at least one micro-battery configuration, and thereby determining at least one battery electrical specification; the first power port 105b is used to couple with at least one external charge and discharge port 101; the second power port 105c is used to provide at least one external charging and discharging port, where the control unit 105 has a power conversion function to convert a first voltage of the first power port 105b to a second voltage, which is output via the second power port 105c.

In addition, the control unit 105 may further have at least one of the following functions: an overcurrent protection function, an over temperature protection function, and an inter-battery energy balancing function, where the inter-battery energy balancing function uses a plurality of the charging and discharging ports 101 to balance the energy among equivalent batteries formed by a plurality of the micro-battery configurations.

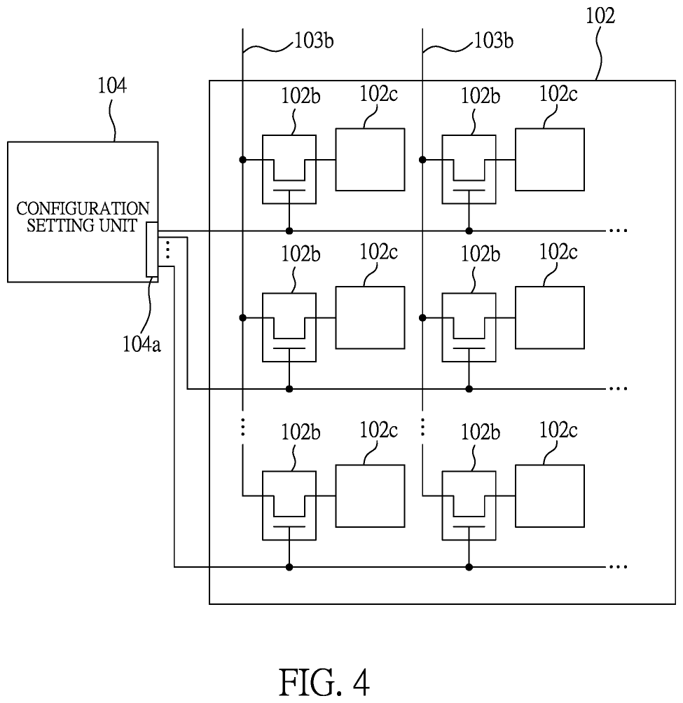

Please refer to FIG. 4, which illustrates an embodiment of a micro-battery unit array 102 of FIG. 3. As illustrated in FIG. 4, each micro control unit 102b has at least one TFT switching element, and the connecting network includes a plurality of gate lines (connected to the first output port 104a of the configuration setting unit 104) and a plurality of source lines (connected to a plurality of first connecting lines 103b). Accordingly, the present invention can detect the status of each of the micro-battery units 102a of the micro-battery unit array 102, and disconnect and isolate failed micro-battery unit(s) 102a.

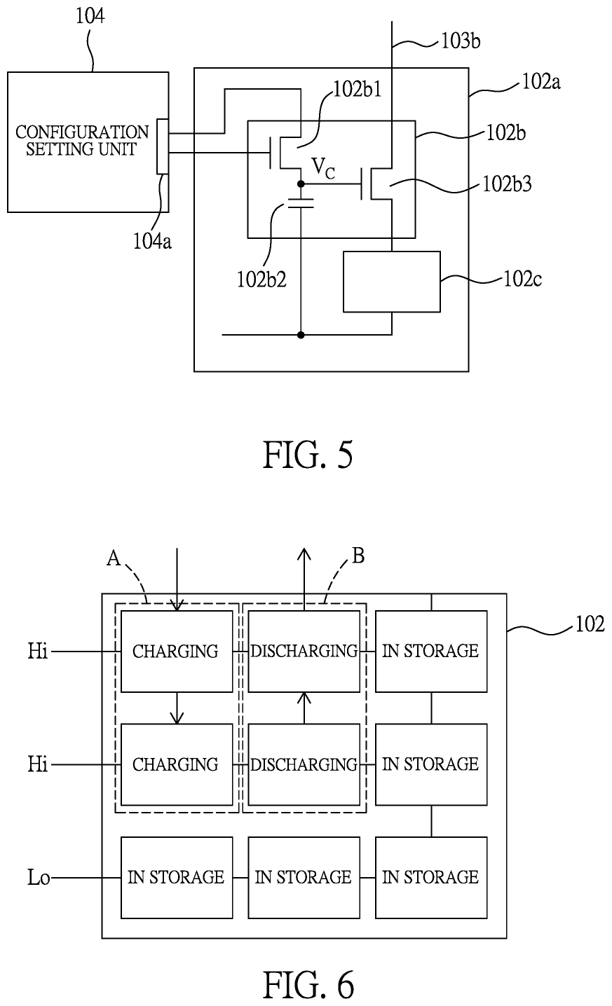

In addition, please refer to FIG. 5, which illustrates another embodiment of the micro-battery unit array of FIG. 3. As illustrated in FIG. 5, the micro control unit 102b has a first transistor 102b1, a memory capacitor 102b2, and a second transistor 102b3, and the connecting network includes a plurality of gate lines and a plurality of first source lines (connected to the first output port 104a of the configuration setting unit 104) and a plurality of second source lines (connected to a plurality of first connecting lines 103b), where the first transistor 102b1 and the memory capacitor 102b2 are used to determine a control voltage VC, the second transistor 102b3 is used to determine a charging or discharging current of an energy storage unit 102c according to the control voltage VC.

Based on the designs mentioned above, the present invention can perform a charging process in one area of the micro-battery unit array 102 through a charging and discharging port 101, and in the same time perform a discharge process in another area of the micro-battery unit array 102 through another charging and discharging port 101. Please refer to FIG. 6, which illustrates an operation scenario of the adaptive micro-battery array using active control of FIG. 1, where a charging process and a discharging process are performed in two separate regions (A and B) of the micro-battery unit array 102 simultaneously.

Thanks to the designs disclosed above, the present invention offers the following advantages:

1. The adaptive micro-battery array using active control of the present invention can provide variable battery electrical specifications.

2. The adaptive micro-battery array using active control of the present invention can provide multiple sets of charging and discharging ports, each of the charging and discharging ports can have different battery electrical specifications, and the charging and discharging ports can be charged or discharged independently in the same time.

3. The adaptive micro-battery array using active control of the present invention can detect the status of internal micro-batteries and disable a failed micro-battery(ies).

4. The adaptive micro-battery array using active control of the present invention can perform an energy balancing procedure on a plurality of internal micro-batteries.

5. The adaptive micro-battery array using active control of the present invention can provide over temperature protection for a plurality of internal micro-batteries.

6. The adaptive micro-battery array using active control of the present invention can provide overcurrent protection for a plurality of internal micro-batteries.

7. The adaptive micro-battery array using active control of the present invention can be implemented on a flexible substrate using a semiconductor fabrication process.

8. The adaptive micro-battery array using active control of the present invention can integrate a capacitor, a solar cell, or a display element into an internal micro-battery unit.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. An adaptive micro-battery array using active control comprising:
a substrate having at least one charging and discharging port;
a plurality of micro-battery units located on the substrate and each having at least one micro control unit and at least one energy storage unit; and
a connecting network, located on the substrate and connected to the plurality of micro-battery units and the at least one charging and discharging port;
wherein the connecting network and the micro control unit are formed on the substrate by a semiconductor fabrication process, and each of the micro-battery units is controlled by the at least one micro control unit therein to determine whether to make the at least one energy storage unit electrically connected to the connecting network, so that each of the at least one charging and discharging port, which is electrically connected with the connecting network, is electrically connected with a corresponding micro-battery configuration, wherein the micro-battery configuration is formed by a series connection, a parallel connection, or a series and parallel combined connection of a plurality of the micro-battery units to provide a battery electrical specification.

2. The adaptive micro-battery array using active control according to claim 1, wherein the substrate is a rigid or flexible substrate of organic material or inorganic material.

3. The adaptive micro-battery array using active control of claim 2, wherein the semiconductor fabrication process is selected from a group consisting of a TFT panel fabrication process, a wafer fabrication process, and a thin film fabrication process.

4. The adaptive micro-battery array using active control of claim 1, wherein the at least one micro control unit has at least one local control function selected from a group consisting of enabling or disabling at least one of the micro-battery units, setting a connecting configuration of the at least one energy storage unit of at least one of the micro-battery units, setting a charging current of at least one of the micro-battery units, setting an overcurrent protection function for at least one of the micro-battery units, setting an over temperature protection function for at least one of the micro-battery units, and setting an energy balancing function for the energy storage units of at least one of the micro-battery units.

5. The adaptive micro-battery array using active control of claim 1, wherein the connecting network includes a plurality of multiplexers coupled with the at least one charging and discharging port, and the multiplexers are formed on the substrate by the semiconductor fabrication process.

6. The adaptive micro-battery array using active control of claim 1, further comprising a configuration setting unit, and the configuration setting unit being electrically connected with the plurality of micro-battery units and the connecting network to configure the connecting network and the at least one micro control unit of each of the micro-battery units according to a configuration data, so as to set at least one said micro-battery configuration to provide at least one said battery electrical specification, and the configuration setting unit being formed on the substrate by using the semiconductor fabrication process or being an add-on chip on the substrate.

7. The adaptive micro-battery array using active control of claim 6, further comprising a control unit coupled to the configuration setting unit to determine the configuration data to set at least one said micro-battery configuration, so as to provide at least one said battery electrical specification, and the control unit being formed on the substrate by using the semiconductor fabrication process or being an add-on chip on the substrate.

8. The adaptive micro-battery array using active control of claim 7, wherein the control unit is further coupled with the at least one charging and discharging port and has a power conversion function.

9. The adaptive micro-battery array using active control according to claim 8, wherein the control unit further has at least one function selected from a group consisting of an overcurrent protection function, an over temperature protection function, and an inter-battery energy balancing function.

10. The adaptive micro-battery array using active control of claim 1, wherein the energy storage unit includes a solid state battery or a solid state capacitor, or includes a solid state battery and at least one component selected from a group consisting of a solid capacitor, a solar cell and a display component, where the solid state battery or the solid state capacitor has a single layer structure or a multilayer stack structure.

11. The adaptive micro-battery array using active control of claim 1, wherein the substrate has at least two charging and discharging ports for performing at least one charging process and at least one discharging process simultaneously in at least two separate regions in the adaptive micro-battery array using active control.

12. The adaptive micro-battery array using active control of claim 1, wherein the micro control unit has at least one TFT switching element, and the connecting network includes a plurality of gate lines and a plurality of source lines.

13. The adaptive micro-battery array using active control of claim 1, wherein the micro control unit has a first transistor, a memory capacitor, and a second transistor, and the connecting network includes a plurality of gate lines and a plurality of source lines, where the first transistor and the memory capacitor are used to determine a control voltage, and the second transistor is configured to determine a charging or discharging current of one of the energy storage units according to the control voltage.
